(19) United States
(12) Patent Application Publication
(10) Pub. No.: US 2026/0227173 A1
(43) Pub. Date: Aug. 6, 2026

(54) LASER INTERFEROMETER AND METHOD FOR PERFORMING OPTICAL AXIS ADJUSTMENT IN LASER INTERFEROMETER

(71) Applicant: SEIKO EPSON CORPORATION, TOKYO (JP)

(72) Inventor: Jun KITAGAWA, Matsumoto-shi (JP)

(21) Appl. No.: 19/530,598

(22) Filed: Feb. 5, 2026

(30) Foreign Application Priority Data
Feb. 5, 2025 (JP) 2025-017401

(51) Int. Cl. G01B 9/02015; G01B 9/02

(52) U.S. Cl. CPC G01B 9/02027; G01B 9/02089

(57) ABSTRACT

The laser interferometer includes a laser light source, a first light splitter that splits laser light into first light and second light, a light modulator that generates reference light, a first light receiver that receives the reference light and object light and outputs a light reception signal, a second light splitter disposed in an optical path and configured to guide return light of the reference light and return light of the object light to a second optical path different from a first optical path extending toward the laser light source, a second light receiver that acquires light reception positions where the two types of return light are received, an processor that acquires an AC level generated by interference between the reference light and the object light contained in the light reception signal, and an AC level at least one display that displays the light reception positions and the AC level.

The present application is based on, and claims priority from JP Application Serial Number 2025-017401, filed February 5, 2025, the disclosure of which is hereby incorporated by reference herein in its entirety.

### BACKGROUND

### 1. Technical Field

The present disclosure relates to a laser interferometer and a method for performing optical axis adjustment in the laser interferometer.

### 2. Related Art

JP-A-2007-285898 discloses a laser vibrometer as an apparatus that measures a vibration speed of an object. The laser vibrometer irradiates an object under measurement with laser light and measures the vibration speed based on scattered laser light subjected to a Doppler shift.

The laser vibrometer described in JP-A-2007-285898 includes a vibrating element that generates a predetermined frequency. The vibrating element shifts the frequency of incident laser light based on the vibration frequency of the vibrating element to generate reflected laser light having a frequency different from that of the incident laser light. In the laser vibrometer, the reflected laser light is used as reference light. A photodetector then receives the combination of the scattered laser light derived from the object under measurement and the reference light, electrically extracts a beat signal from the received light, and the vibration speed of the object under measurement is measured from the beat signal.

In a laser light source, however, laser oscillation may become unstable due to entry of return light into the laser light source. The return light refers to laser light that is output from the laser light source, is reflected off an optical component, and unintentionally returns toward the laser light source. When the laser oscillation becomes unstable, the quality of the laser light decreases. The laser vibrometer therefore suffers from a decrease in the S/N ratio (signal-to-noise ratio), and discontinuity of the phase of the laser light. As a result, the vibration speed of the object is measured with lowered accuracy.

A non-coaxial optical system is known as a technology for suppressing the return light. The non-coaxial optical system is an optical system in which a reflection surface of an optical component is so tilted that light incident on the optical component (incident light) and the light reflected off the optical component (reflected light) propagate along respective axes different from each other. Even when part of the reflected light returns toward the laser light source, the tilted reflection surface causes the reflected light to return to a position shifted from the laser light source. Entry of the return light into a light exiting portion of the laser light source can therefore be suppressed.

It is conceivable that the non-coaxial optical system described above can be used in the laser vibrometer to suppress the instable laser oscillation due to the return light.

JP-A-2007-285898 is an example of the related art.

When the non-coaxial optical system is used in the laser vibrometer described in JP-A-2007-285898, the scattered laser light (object light) derived from the object under measurement and the reference light are combined with each other and received by the photodetector. In this process, when the optical axis of the object light and the optical axis of the reference light are not parallel to each other, interference occurs in a region where the two beams overlap with each other (overlapping region). When the optical axes of the beams are parallel to each other, there is no difference in optical path length at each point in the overlapping region, so that there is no difference in the interference state. However, when the optical axes of the beams are not parallel to each other, a difference occurs in the optical path length at each point in the overlapping region, so that a difference also occurs in the interference state. Therefore, when the interference state is observed at an observation plane that intersects with the optical axes, bright and dark fringes (interference fringes) are observed.

The photodetector is placed at the observation plane, and therefore detects the intensities of the interference fringes in the form of an averaged intensity. As a result, the S/N ratio of a light reception signal decreases.

It is therefore required to perform optical axis adjustment in a way that no interference fringes are generated in the overlapping region in the non-coaxial optical system to suppress the decrease in the S/N ratio of the light reception signal.

### SUMMARY

A laser interferometer according to an application example of the present disclosure includes:

a laser light source configured to output laser light;

a first light splitter configured to split the laser light into first light and second light;

a light modulator configured to modulate a frequency of the first light to generate reference light;

a first light receiver configured to receive the reference light and object light generated by irradiating a target object with the second light and output a light reception signal based on an intensity of the received light;

a second light splitter disposed in an optical path that couples the laser light source and the first light splitter to each other and configured to guide return light of the reference light and return light of the object light that are generated at the first light splitter to a second optical path different from a first optical path extending toward the laser light source;

a second light receiver disposed in the second optical path and configured to acquire light reception positions where the return light of the reference light and the return light of the object light are received;

a light reception position display configured to display the acquired light reception positions;

an processor configured to acquire an AC level generated by interference between the reference light and the object light contained in the light reception signal; and

an AC level display configured to display the acquired AC level.

A method for performing optical axis adjustment in a laser interferometer according to another application example of the present disclosure is a method for performing optical axis adjustment in a laser interferometer, the laser interferometer including

a laser light source configured to output laser light,

a first light splitter configured to split the laser light into first light and second light,

a light modulator configured to modulate a frequency of the first light to generate reference light,

a first light receiver configured to receive the reference light and object light generated by irradiating a target object with the second light and output a light reception signal based on an intensity of the received light,

a second light splitter disposed in an optical path that couples the laser light source and the first light splitter to each other and configured to guide return light of the reference light and return light of the object light that are generated at the first light splitter to a second optical path different from a first optical path extending toward the laser light source, and

a second light receiver disposed in the second optical path and configured to acquire light reception positions where the return light of the reference light and the return light of the object light are received, and

the method includes:

moving the light reception position where the return light of the object light is received to a start point by performing a changing operation of changing a relative relationship between the laser interferometer and the target object based on the light reception positions acquired by the second light receiver;

acquiring an AC level generated by interference between the reference light and the object light contained in the light reception signal while performing a sweeping operation of continuously changing the relative relationship from the start point; and

terminating the sweeping operation when the acquired AC level satisfies a predetermined condition.

### BRIEF DESCRIPTION OF THE DRAWINGS

FIG. 1 is a block diagram showing a laser interferometer according to an embodiment.

FIG. 2 is a schematic configuration diagram showing an interference optical system provided in the laser interferometer shown in FIG. 1.

FIG. 3 shows an example of the external view of a sensor head unit shown in FIG. 1.

FIG. 4 is a flowchart showing the configuration of a method for performing optical axis adjustment in the laser interferometer according to the embodiment.

FIG. 5 shows an example of return light reception positions and a warning range that are displayed on a light reception position display.

FIG. 6 shows an example in which an operation teaching portion teaches a user to change the posture of a graphic that imitates an enclosure.

FIG. 7 shows a table that summarizes the relationship among three positions through which return light passes in the course of sweeping operation and which are displayed on the light reception position display shown in FIG. 5, an AC level corresponding to each of the positions, the directions in which reference light and object light are incident, images of interference between the reference light and the object light, positional deviation and angular deviation between the reference light and the object light, whether interference fringes have been generated, and the like.

FIG. 8 is a schematic configuration diagram showing an interference optical system provided in a laser interferometer according to a first variation.

FIG. 9 is a schematic configuration diagram showing an interference optical system provided in a laser interferometer according to a second variation.

### DESCRIPTION OF EMBODIMENTS

A laser interferometer and a method for performing optical axis adjustment in the laser interferometer according to an embodiment of the present disclosure will be described below in detail with reference to the accompanying drawings.

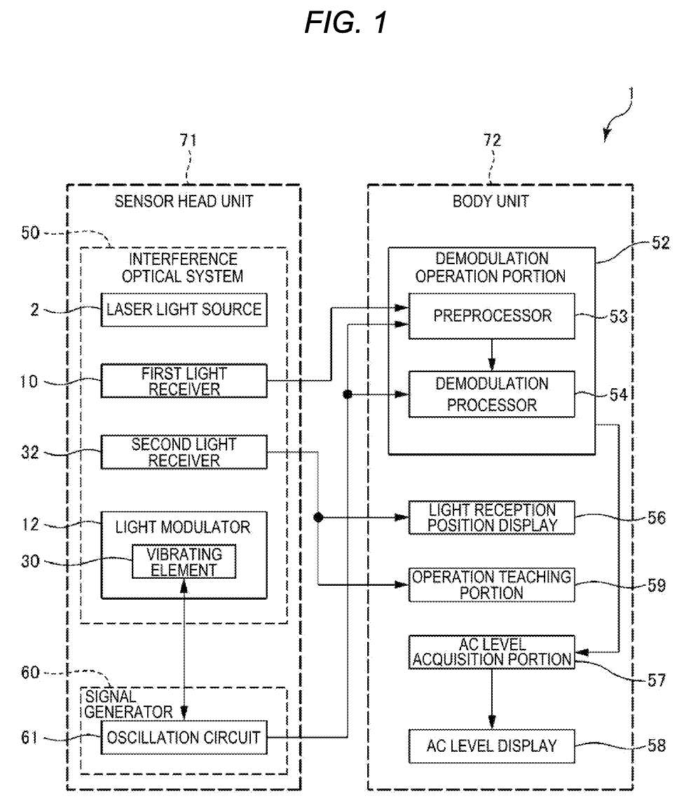

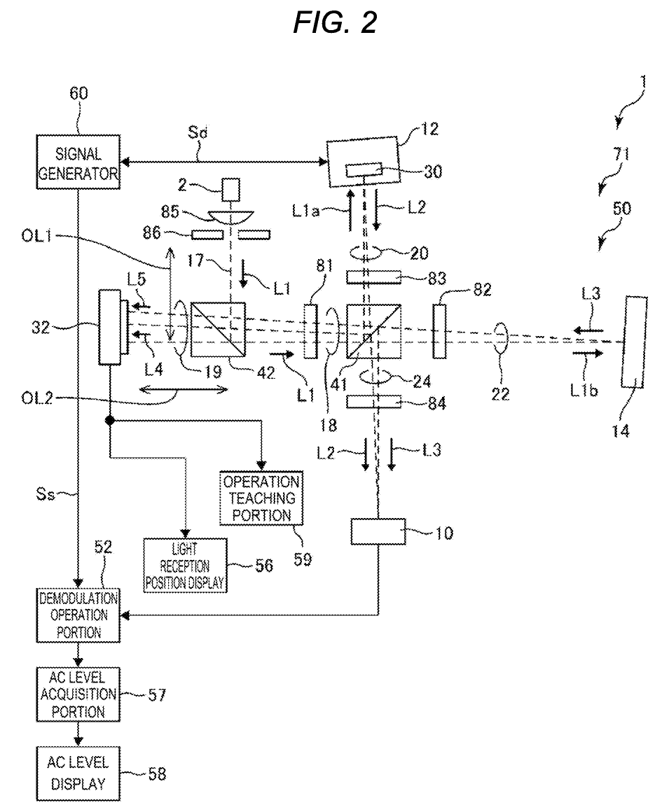

FIG. 1 is a block diagram showing a laser interferometer 1 according to the embodiment. FIG. 2 is a schematic configuration diagram showing an interference optical system 50 provided in the laser interferometer 1 shown in FIG. 1.

The laser interferometer 1 shown in FIG. 1 irradiates a target object 14 and a light modulator 12 shown in FIG. 2 with laser light. The laser light output from the target object 14 and the laser light output from the light modulator 12 are then caused to interfere with each other, and the interference light is received by a first light receiver 10. Information derived from the target object 14 is then extracted based on optical heterodyne interferometry, and the displacement and speed of the target object 14 are measured based on the information.

The laser interferometer 1 shown in FIG. 1 includes a sensor head unit 71 and a body unit 72.

The sensor head unit 71 is readily reduced in size and weight, and is therefore readily carried around and installed, so that the sensor head unit 71 can be disposed, for example, near the target object 14 shown in FIG. 2, which is a target to be measured by the laser interferometer 1.

The body unit 72 includes a demodulation operation portion 52, a light reception position display 56, an processor 57, an AC level display 58, and an operation teaching portion 59. The body unit 72 can be integrated with the sensor head unit 71, but can be disposed at a distance from the sensor head unit 71, can be a stationary portion which can be housed, for example, in a rack, or can be a portable portion that can be carried around. At least one of the above functional portions provided in the body unit 72 may be disposed in the sensor head unit 71.

### 1. Laser interferometer

The sensor head unit 71 shown in FIG. 1 includes the interference optical system 50, a signal generator 60, and an enclosure 70, which houses the two elements.

### 1.1. Interference optical system

The interference optical system 50 shown in FIG. 2 is a Michelson interference optical system. The interference optical system 50 includes a laser light source 2, a collimation lens 85, a blocker 86, a first light splitter 41, a half-wave plate 81, a quarter-wave plate 82, a quarter-wave plate 83, an analyzer 84, the first light receiver 10, the light modulator 12, a second light splitter 42, and a second light receiver 32.

An optical path that couples the laser light source 2 to the second light splitter 42 is referred to as an optical path 17 (first optical path). An optical path that couples the second light splitter 42 to the first light splitter 41 is referred to as an optical path 18. An optical path that couples the first light splitter 41 to the light modulator 12 is referred to as an optical path 20. An optical path that couples the first light splitter 41 to the target object 14 is referred to as an optical path 22. An optical path that couples the first light splitter 41 to the first light receiver 10 is referred to as an optical path 24. Note that the "optical path" in the present specification refers to a path which is set between optical components and along which light travels. An "optical axis" that will be described later refers to a center axis of a traveling beam.

The laser light source 2 outputs laser light L1. The laser light L1 is incident on the first light splitter 41 via the collimation lens 85 and the blocker 86 provided in the optical path 17, and the second light splitter 42 and the half-wave plate 81 provided in the optical path 18.

The first light splitter 41 is provided in the optical path 18 and splits the laser light L1 into first light L1a and second light L1b.

The first light L1a is radiated to the light modulator 12 via the quarter-wave plate 83 provided in the optical path 20. The light modulator 12 modulates the frequency of the first light L1a. The first light L1a therefore becomes reference light L2 through an interaction such as reflection at the light modulator 12. The reference light L2 enters the first light splitter 41 via the quarter-wave plate 83.

The second light L1b is radiated to the target object 14 via the quarter-wave plate 82 provided in the optical path 22. The target object 14 that is vibrating or otherwise being displaced shifts the frequency of the second light L1b. The second light L1b therefore becomes object light L3 through an interaction such as reflection at the target object 14. The object light L3 enters the first light splitter 41 via the quarter-wave plate 82.

The first light splitter 41 mixes the reference light L2 and the object light L3 with each other. The mixture of the reference light L2 and the object light L3 is incident on the first light receiver 10 via the analyzer 84 provided in the optical path 24.

The first light receiver 10 receives the reference light L2 and the object light L3, and outputs a light reception signal based on the intensities of the two types of received light.

In the thus configured interference optical system 50, information on the phase of the target object 14 is determined based on optical heterodyne interferometry. Specifically, two types of light (reference light L2 and object light L3) slightly different in frequency from each other are caused to interfere with each other, and the phase information is extracted from the resultant interference light. The displacement of the target object 14 is then determined from the phase information in the demodulation operation portion 52, which will be described later. According to the optical heterodyne interferometry, when the phase information is extracted from the interference light, the phase information is unlikely to be affected by disturbance, in particular, stray light, which becomes noise, so that the resultant phase information has highly improved robustness.

The reference light L2 generated by the light modulator 12 and entering the first light splitter 41 passes through the first light splitter 41 and is received by the first light receiver 10, but is partially reflected off the first light splitter 41. There is a concern that the reflected reference light L2 travels as return light L4 along the optical path 18 and the optical path 17 toward the laser light source 2.

Similarly, the object light L3 entering the first light splitter 41 is reflected off the first light splitter 41 and received by the first light receiver 10, but partially passes through the first light splitter 41. There is a concern that the object light L3 having passed through the first light splitter 41 travels as return light L5 along the optical path 18 and the optical path 17 toward the laser light source 2.

When the return light L4 and the return light L5 enter the laser light source 2, the laser oscillation in the laser light source 2 becomes unstable, so that the quality of the laser light L1 deteriorates.

A non-coaxial optical system is therefore employed as the interference optical system 50 shown in FIG. 2. In the interference optical system 50, which is a non-coaxial optical system, the optical path 20 along which the first light L1a travels and the optical path 20 along which the reference light L2 travels deviate from each other. The optical path 22 along which the second light L1b travels and the optical path 22 along which the object light L3 travels also deviate from each other. According to the thus configured non-coaxial optical system, even when part of the reference light L2 travels as the return light L4 toward the laser light source 2, the part of the reference light L2 reaches a position shifted from a light exiting portion via which the laser light L1 is output. Furthermore, even when part of the object light L3 travels as the return light L5 toward the laser light source 2, the part of the object light L3 reaches a position shifted from the light exiting portion, via which the laser light L1 is output. The return light L4 and the return light L5 are therefore unlikely to affect the laser oscillation of the laser light source 2. The light exiting portion refers to a surface of the laser light source 2 via which the laser light L1 is output.

To obtain the effects and advantages described above in the interference optical system 50, it is necessary to strictly perform optical axis adjustment. Specifically, the reference light L2 generated by the light modulator 12 needs to travel toward the first light splitter 41 not along the optical path 20 that is the same as that of the first light L1a but along the optical path 20 slightly tilted therefrom. To this end, it is necessary to tilt the light incident/exiting surface of the light modulator 12 from the light incident/exiting surface of the first light splitter 41. It is, however, difficult to tilt the light incident/exiting surface of the light modulator 12 afterwards (after the interference optical system 50 is housed in the enclosure 70).

The object light L3 generated by the target object 14 needs to travel toward the first light splitter 41 not along the optical path 22 that is the same as that of the second light L1b but along the optical path 22 slightly tilted therefrom. To this end, it is necessary to tilt the light incident/exiting surface of the target object 14 from the interference optical system 50 or tilt the interference optical system 50 from the target object 14. The operation described above is hereinafter also referred to as "the operation of changing the relative relationship between the enclosure 70 and the target object 14". The relative relationship refers to the posture or the position of the enclosure 70 relative to the posture or the position of the target object 14. Since the operation described above can be performed afterwards, a user of the laser interferometer 1 performs the operation described above to perform optical axis adjustment before measuring the position or the like of the target object 14.

In the interference optical system 50, which is a non-coaxial optical system, it is required to perform optical axis adjustment in a way that the following three items (a), (b), and (c) are satisfied.
(a) The return light L4 and the return light L5 are not incident on the light exiting portion of the laser light source 2.
(b) The beam of the reference light L2 and the beam of the object light L3 overlap with each other on the light receiving surface of the first light receiver 10.
(c) The optical axis of the reference light L2 and the optical axis of the object light L3 are parallel to each other on the light receiving surface of the first light receiver 10.

Performing optical axis adjustment in a way that the three items (a), (b), and (c) described above are satisfied can suppress the decrease in the S/N ratio (signal-to-noise ratio) of the light reception signal while suppressing generation of interference fringes due to the interference between the object light L3 and the reference light L2. The laser interferometer 1 can thus be a laser interferometer capable of measuring the displacement or the like of the target object 14 with high accuracy.

It is, however, difficult for the user to perform optical axis adjustment in a way that the three items described above are satisfied.

To address the difficulty, in the laser interferometer 1 according to the present embodiment, the return light L4 and the return light L5 generated at the first light splitter 41, that is, the return light L4 and the return light L5 generated in a direction (direction along the optical path 18) different from the direction of the reference light L2 and the object light L3 directed to the optical path 24 at the first light receiver 10 are observed by the second light receiver 32. Using the result of the observation allows the difficulty of the optical axis adjustment to be reduced. The return light L4 and the return light L5 shown in FIG. 2 will be described below.

The interference optical system 50 shown in FIG. 2 is provided with the second light splitter 42 and the second light receiver 32.

The second light splitter 42 is provided in the optical paths 17 and 18. Therefore, when the return light L4 and the return light L5 return to the laser light source 2 along the optical paths 18 and 17, the return light L4 and the return light L5 enter the second light splitter 42 before reaching the laser light source 2. The second light splitter 42 splits each of the incident return light L4 and the return light L5 into two. One of the portions into which each of the return light L4 and the return light L5 is split is directed to the laser light source 2, and the other portion is directed to the second light receiver 32. An optical path that couples the second light splitter 42 to the second light receiver 32 is referred to as an optical path 19 (second optical path).

The second light receiver 32 provided in the optical path 19 receives the split return light L4 and return light L5 and acquires light reception positions where the two types of return light are received.

The laser interferometer 1 shown in FIGS. 1 and 2 further includes the light reception position display 56, the AC level acquisition portion 57, and the AC level display 58.

The light reception position display 56 displays the light reception positions on the second light receiver 32 at which the return light L4 and the return light L5 acquired by the second light receiver 32 are received.

The AC level acquisition portion 57 acquires an AC level generated by the interference between the object light L3 and the reference light L2 contained in the light reception signal.

The AC level display 58 displays the acquired AC level.

According to the configuration described above, when the user of the laser interferometer 1 changes the relative relationship between the enclosure 70 and the target object 14 to perform the optical axis adjustment, information for satisfying the three items (a), (b), and (c) described above can be given to the user. Specifically, causing the user to recognize the content displayed on the light reception position display 56 can assist the optical axis adjustment in a way that the items (a) and (b) are primarily satisfied. Furthermore, causing the user to recognize the content displayed on the AC level display 58 can assist the optical axis adjustment in a way that the items (b) and (c) are primarily satisfied.

The operation teaching portion 59 teaches the changing operation described above to the user of the laser interferometer 1 based on the acquired light reception positions. Therefore, when the user changes at least one of the posture and the position of the enclosure 70 and the posture and the position of the target object 14, the user readily understands the direction of the change, the amount of the change, and the like. As a result, the user can readily complete the optical axis adjustment in a short period. Note that the enclosure 70 and the operation teaching portion 59 may be provided as necessary, and may be omitted. When the enclosure 70 is omitted, the relative relationship between the interference optical system 50 (the laser interferometer 1) and the target object 14 may be changed.

The portions that constitute the interference optical system 50 will further be described below.

### 1.1.1. Laser light source

The laser light source 2 outputs the laser light L1, which is coherent light. The laser light source 2 is preferably a light source that outputs light having a linewidth that falls within a MHz band or a lower frequency band. Specific examples of the laser light source 2 may include gas lasers such as a He-Ne laser, and semiconductor laser devices such as a distributed feedback laser diode (DFB-LD), a fiber Bragg grating laser diode (FBG-LD), a vertical cavity surface emitting laser (VCSEL), and a Fabry-Perot laser diode (FP-LD).

It is particularly preferable that the laser light source 2 is a semiconductor laser device. In particular, the size of the laser light source 2 can thus be reduced in size. As a result, since the sensor head unit 71, in which the interference optical system 50 is housed, is reduced in size and weight, the degree of freedom of installation, portability, operability, and other factors of the sensor head unit 71 are improved.

The laser light L1 output from the laser light source 2 sequentially passes through the collimation lens 85 and the blocker 86 provided in the optical path 17, and the second light splitter 42 and the half-wave plate 81 provided in the optical path 18, and enters the first light splitter 41.

### 1.1.2. Collimation lens

The collimation lens 85 parallelizes the laser light L1 output from the laser light source 2. The collimation lens 85 may, for example, be an aspherical lens. Note that when the light L1 output from the laser light source 2 is sufficiently parallelized, for example, when a gas laser such as a He-Ne laser is used as the laser light source 2, the collimation lens 85 may be omitted.

When the laser light source 2 is a semiconductor laser device, it is preferable to provide the collimation lens 85. Since the laser light L1 is thus collimated light, an increase in the size of each of various optical components that receive the laser light L1 can be suppressed, so that the size of the laser interferometer 1 can be reduced.

The laser light L1 having become collimated light passes through the half-wave plate 81, which converts the laser light L1 into linearly-polarized light having an intensity ratio of, for example, 50:50 between P-polarized light and S-polarized light, and the linearly-polarized laser light L1 then enters the first light splitter 41.

### 1.1.3. Blocker

The blocker 86 is an aperture disposed between the collimation lens 85 and the second light splitter 42. The blocker 86 has an opening provided in correspondence with the optical path 17. The blocker 86 more reliably prevents the return light L4 and the return light L5 from being incident on the light exiting portion of the laser light source 2, as shown in FIG. 2. Note that the blocker 86 only needs to be a member having a slit, a pinhole, or the like, and does not necessarily have a specific structure. In addition, the blocker 86 only needs to be provided as necessary, and may be omitted when the incidence of the return light L4 and the return light L5 on the light exiting portion can be suppressed without the blocker 86.

### 1.1.4. First light splitter

The first light splitter 41 is, for example, a polarizing beam splitter. The first light splitter 41 has the function of transmitting P-polarized light and reflecting S-polarized light. The first light splitter 41, which has the function described above, reflects part of the laser light L1 to generate the first light L1a, and transmits the other part of the laser light L1 to generate the second light L1b.

The first light L1a is converted by the quarter-wave plate 83 into circularly polarized light, which is incident on the light modulator 12. The first light L1a incident on the light modulator 12 is subjected to a frequency shift by fₘ [Hz], and is reflected as the reference light L2. The reference light L2 therefore contains a modulated component having the frequency fₘ [Hz]. When passing through the quarter-wave plate 83, the reference light L2 is converted into P-polarized light, which enters the first light splitter 41.

The second light L1b is converted by the quarter-wave plate 82 into circularly polarized light, which is incident on the target object 14. The second light L1b incident on the target object 14 is subjected to a Doppler shift by f_{d} [Hz] and is reflected as the object light L3. The object light L3 therefore contains a sample derived component having the frequency f_{d} [Hz]. When passing through the quarter-wave plate 82, the object light L3 is converted into S-polarized light, which enters the first light splitter 41.

The first light splitter 41 also has the function of mixing the reference light L2 and the object light L3 with each other. The mixture of the reference light L2 and the object light L3 passes through the analyzer 84 and is incident on the first light receiver 10.

Note that the first light splitter 41 may instead be a non-polarizing beam splitter in place of the polarizing beam splitter. In this case, the half-wave plate 81, the quarter-wave plate 82, the quarter-wave plate 83, and other elements become unnecessary, so that reduction in the size of the laser interferometer 1 resulting from the reduction in the number of the components can be achieved. Still instead, a light splitter other than a beam splitter may be used.

S-polarized light and P-polarized light, which are polarized in directions perpendicular to each other, are independent of each other, and therefore do not produce beating due to interference when simply superimposed on each other. In view of the fact described above, the mixture of the reference light L2 and the object light L3 is caused to pass through the analyzer 84 having a transmission axis tilted by 45° from the polarization directions of the S-polarized light and the P-polarized light. The analyzer 84 can transmit light beams having a common component to cause interference between the light beams. As a result, the reference light L2 and the object light L3 satisfactorily interfere with each other, and interference light having a frequency |fₘ-f_{d}| [Hz] is generated.

### 1.1.5. First light receiver

When the interference light is incident on the first light receiver 10, the first light receiver 10 outputs a photocurrent (light reception signal) according to the intensity of the interference light (intensity of received light). Demodulating the light reception signal to extract the sample derived component by using a method that will be described later allows determination of the movement, that is, the displacement and the speed of the target object 14. The first light receiver 10 may, for example, be a photodiode. Note that the light received by the first light receiver 10 is not limited to the interference light as a result of the interference having occurred along the path described above, and may be any light containing the sample derived component and the modulated component. The phrase "demodulating the light reception signal to extract the sample derived component" in the present specification includes processing the photocurrent (light reception signal) in various manners and then demodulating the processed light reception signal to extract the sample derived component.

### 1.1.6. Light modulator

The light modulator 12 will next be described.

The light modulator 12 operates based on a drive signal Sd input from the signal generator 60 and shifts the frequency of the laser light L1. Examples of the thus configured light modulator 12 may include an acousto-optical modulator (AOM), an electro-optical modulator (EOM), a semiconductor optical modulator, and a vibrator-type light modulator.

A vibrator-type light modulator including a vibrating element 30 is preferably used as the light modulator 12, as shown in FIGS. 1 and 2. The vibrator-type light modulator is, for example, a light modulator including a vibrating element such as that disclosed in JP-A-2022-038156, includes the vibrating element 30, and shifts the frequency of the laser light L1 by using the vibration of the vibrating element 30. Examples of the vibrating element 30 may include a quartz crystal vibrator, a silicon vibrator, and a ceramic vibrator. Using the thus configured vibrating element 30 allows reduction in the size, weight, power consumption, and other factors of the light modulator 12.

### 1.1.7. Second light splitter

The second light splitter 42 is, for example, a non-polarizing beam splitter. The non-polarizing beam splitter may be a cube-shaped beam splitter, a plate-shaped beam splitter, or a beam splitter having any other shape. The second light splitter 42 splits each of the return light L4 of the reference light L2 and the return light L5 of the object light L3 at a predetermined splitting ratio irrespective of the type of polarization of the light to be split. The splitting ratio of the second light splitter 42 is not limited to a specific value, and is preferably so set that the amount of light traveling toward the laser light source 2 is greater than the amount of light traveling toward the second light receiver 32. That is, the splitting ratio in accordance with which the return light L4 and the return light L5 are each split is preferably so set that the amount of light traveling along the optical path 19 (second optical path) is smaller than the amount of light traveling along the optical path 17 (first optical path). Therefore, also when the laser light L1 output from the laser light source 2 is split by the second light splitter 42, the amount of light traveling toward the first light splitter 41 can be increased. As a result, the amount of each of the reference light L2 and the object light L3 received by the first light receiver 10 can be increased. When the return light L4 and the return light L5 are split by the second light splitter 42, the amount of light traveling toward the laser light source 2 is relatively large, and the amount of light traveling toward the second light receiver 32 is relatively small, but the second light receiver 32 can acquire the light reception positions even when the amount of each of the return light L4 and the return light L5 is small, so that problems hardly occur.

The splitting ratio of the second light splitter 42 is so set that a value I2/I1, which is the ratio of an amount I2 of each of the return light L4 and the return light L5 traveling along the optical path 19 (second optical path) to an amount I1 of the light traveling along the optical path 17 (first optical path), is preferably greater than or equal to 1/99 but smaller than or equal to 50/50, more preferably, greater than or equal to 5/95 but smaller than or equal to 30/70.

An optical path length OL1 of the optical path 17 (first optical path) and an optical path length OL2 of the optical path 19 (second optical path) are preferably equal to each other. The positions where the return light L4 and the return light L5 returning along the optical path 17 reach the laser light source 2 therefore coincide with the positions where the return light L4 and the return light L5 returning along the optical path 19 reach the second light receiver 32. That is, the latter positions reached by the two types of return light reflect the former positions reached by the two types of return light. Detecting the latter positions reached by the two types of return light with the second light receiver 32 therefore allows the former positions reached by the two types of return light to be more accurately monitored. The situation in which the return light L4 and the return light L5 return to the laser light source 2 can thus be readily detected, so that the optical axis adjustment can be more efficiently performed.

It is preferable that the optical path length OL1 is defined as the optical distance from the intersection where the optical path 17 intersects with the light splitting surface of the second light splitter 42 to the blocker 86. Further, it is preferable that the optical path length OL2 is defined as the optical distance from the intersection where the optical path 19 intersects with the light splitting surface of the second light splitter 42 to the light receiving surface of the second light receiver 32.

### 1.1.8. Second light receiver

The second light receiver 32 is disposed in the optical path 19 (second optical path) and receives each of the return light L4 of the reference light L2 and the return light L5 of the object light L3 which is split by the second light splitter 42. The light reception positions where the return light L4 and the return light L5 are received are thus acquired.

The second light receiver 32 is a light receiver capable of acquiring a one-dimensional or two-dimensional distribution of the intensity of the received light. Examples of the thus configured light receiver may include a charge coupled device (CCD), a complementary metal oxide semiconductor (CMOS) device, a line sensor, and an area sensor. Out of the elements described above, a light receiver capable of acquiring a two-dimensional distribution is preferably used. The light reception positions can thus be more accurately acquired, so that the user can more readily perform the optical axis adjustment.

The second light receiver 32 may have the function of acquiring not only the light reception positions but also the intensities of the two types of received light. The user can therefore perform the optical axis adjustment based not only on the light reception positions but also on the intensities of the two types of received light. As a result, more accurate optical axis adjustment can be efficiently performed.

### 1.2. Signal generator

The signal generator 60 shown in FIG. 1 outputs the drive signal to be input to the light modulator 12, and a reference signal to be input to the demodulation operation portion 52.

In the present embodiment, the signal generator 60 includes an oscillation circuit 61, as shown in FIG. 1. The oscillation circuit 61 operates based on the vibration element 30 as a signal source, and generates a highly accurate periodic signal. The oscillation circuit 61 thus outputs a highly accurate drive signal and a reference signal. The drive signal and the reference signal are therefore affected in the same manner when the two signals are subjected to disturbance. As a result, the modulated component generated by the vibrating element 30 driven by the drive signal, and the reference signal are also affected in the same manner. Therefore, when the modulated component and the reference signal are subjected to the operation performed by the demodulation operation portion 52, the influence of the disturbance that affects both of the modulated component and the reference signal can be canceled out or reduced in the course of the operation. As a result, the demodulation operation portion 52 can provide the modulated component and the reference signal with improved robustness against disturbance. Furthermore, the size, weight, and power consumption of the laser interferometer 1 can therefore be reduced.

The oscillation circuit 61 may, for example, be the oscillation circuit disclosed in JP-A-2022-038156.

The signal generator 60 may instead include a signal generator such as a function generator or a signal generator in place of the oscillation circuit 61.

### 1.3. Enclosure

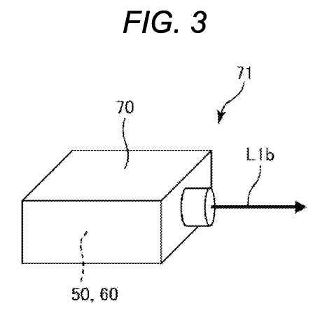

FIG. 3 shows an example of the external view of the sensor head unit 71 shown in FIG. 1.

The sensor head unit 71 shown in FIG. 3 includes the enclosure 70. The enclosure 70 houses the interference optical system 50 and the signal generator 60. That is, the enclosure 70 houses at least the laser light source 2, the first light splitter 41, the light modulator 12, the first light receiver 10, the second light splitter 42, and the second light receiver 32. The interference optical system 50 and the signal generator 60 can thus be protected from foreign matter, external forces, environmental changes, and the like. In addition, the user can readily grip the sensor head unit 71 and change the posture and the position of the sensor head unit 71.

The outer shape of the enclosure 70 is not limited to the box-like shape shown in FIG. 3, and may be any shape.

Examples of the material of which the enclosure 70 is made may include a resin material, a metal material, and a glass material. The material may be a composite material that is a combination of two or more of the materials described above.

### 1.4. Demodulation operation portion

The demodulation operation portion 52 shown in FIG. 1 includes a preprocessor 53 and a demodulation processor 54.

The preprocessor 53 and the demodulation processor 54 may, for example, be the preprocessor and the demodulation portion disclosed in JP-A-2022-038156.

The preprocessor 53 performs preprocessing on the light reception signal based on a reference signal Ss. In the preprocessing, the light reception signal is divided into two signals, then one of the two signals is multiplied by the reference signal, and then the two signals are summed into a preprocessed signal, which is output.

The demodulation processor 54 demodulates the preprocessed signal output from the preprocessor 53 to extract the sample derived component according to the speed and the position of the target object 14 based on the reference signal Ss.

The demodulation processor 54 calculates the position of the target object 14 from the sample derived component, specifically, the phase information derived from the target object 14 and contained in the preprocessed signal. In this case, the laser interferometer 1 is used as a displacement meter. The demodulation processor 54 determines the speed of the target object 14 from the change in the position thereof. In this case, the laser interferometer 1 is used as a speedometer.

### 1.5. Light reception position display

The light reception position display 56 shown in FIG. 1 displays the light reception positions where the return light L4 and the return light L5 are received and which have been acquired by the second light receiver 32. The light reception positions are preferably displayed in real time or at timings comparable thereto. The user can thus readily recognize the relative relationship between the enclosure 70 and the target object 14 from the light reception positions where the return light L4 and the return light L5 are received, so that the difficulty of the optical axis adjustment can be reduced.

Examples of the light reception position display 56 may include a liquid crystal display panel, an organic electro luminescence (EL) display panel, and an image projector. The light reception position display 56 may instead, for example, be a display apparatus having the function of displaying a light reception position in the form of a change in the amount of emitted light or sound volume, a change in a graphic or a pattern, a voice, a character, or the like. Note that the light reception position display 56 also has the function of generating an image signal or the like to display an image or the like on any of the display apparatuses described above.

The light reception position display 56 may have the function of displaying not only the light reception positions but also the intensities of received light. The user can therefore perform the optical axis adjustment based not only on the light reception positions but also on the intensities of received light. As a result, more accurate optical axis adjustment can be efficiently performed.

### 1.6. AC level acquisition portion

The AC level acquisition portion 57 shown in FIG. 1 acquires an AC level generated by the interference between the reference light L2 and the object light L3 contained in the light reception signal. The light reception signal generated by the interference between the reference light L2 and the object light L3 contains a direct current component (DC component) and an alternating current component (AC component). The AC level acquisition portion 57 acquires the intensity (AC level) of the AC component contained in the light reception signal. The AC level is acquired, for example, by detecting an envelope of the light reception signal and quantifying the amplitude of the detected envelope.

### 1.7. AC level display

The AC level display 58 shown in FIG. 1 displays the AC level acquired by the AC level acquisition portion 57. The AC level rises when the beam of the reference light L2 and the beam of the object light L3 overlap with each other on the light receiving surface of the first light receiver 10, and when the optical axis of the reference light L2 and the optical axis of the object light L3 become parallel to each other. The user can therefore efficiently perform the changing operation described above by performing the optical axis adjustment while recognizing the AC level.

Examples of the AC level display 58 may include a liquid crystal display panel, an organic EL display panel, and an image projector. The AC level display 58 may instead, for example, be a display apparatus having the function of displaying the AC level in the form of a change in the amount of emitted light or sound volume, a change in a graphic or a pattern, a voice, a character, or the like. Note that the AC level display 58 also has the function of generating an image signal or the like to display an image or the like on any of the display apparatuses described above.

The AC level display 58 may be integrated with the light reception position display 56. That is, both the light reception positions and the AC level may be displayed on the same display apparatus. The user can thus visually recognize the light reception positions and the AC level at the same time, and can therefore operate the laser interferometer 1 with the two parameters associated with each other. As a result, the accuracy and reliability of the operation can be improved.

### 1.8. Operation teaching portion

When the return light L4 of the reference light L2 and the return light L5 of the object light L3 are received by the second light receiver 32, the operation teaching portion 59 shown in FIG. 1 teaches the user the changing operation of changing the relative relationship between the enclosure 70 and the target object 14 based on the light reception positions. Providing the thus configured operation teaching portion 59 allows the user to efficiently perform the optical axis adjustment even when the user has little experience. A method for teaching the changing operation is not limited to a specific method, and examples of the method may include a method using a change in the amount of emitted light or sound volume, a change in a graphic or a pattern, a voice, a character, or the like.

The operation teaching portion 59 may have the function of displaying the content of the teaching superimposed on the light reception positions on the light reception position display 56. The user can thus visually recognize the light reception positions and the content of the teaching at the same time, so that the user can perform the operation in accordance with the content of the teaching and visually recognize the light reception positions indicating the result of the operation. As a result, the accuracy and reliability of the operation can be improved.

Note that the operation teaching portion 59 may be provided as necessary, and may be omitted.

### 1.9. Hardware configuration

The functions of the demodulation operation portion 52, the AC level acquisition portion 57, and the operation teaching portion 59 are realized, for example, by hardware including a processor, a memory, an external interface, an input portion, and the like. The functions are specifically realized by the processor reading and executing a program stored in the memory. Note that the elements that constitute the hardware can communicate with each other via an external bus.

Examples of the processor may include a central processing unit (CPU) and a digital signal processor (DSP). Note that the configuration in which any of the processors described above executes software may be replaced with a configuration in which a field-programmable gate array (FPGA), an application-specific integrated circuit (ASIC), or the like realizes the functions described above.

Examples of the memory may include a hard disk drive (HDD), a solid-state drive (SSD), an electrically erasable programmable read-only memory (EEPROM), a read-only memory (ROM), and a random access memory (RAM).

Examples of the external interface may include a digital input/output port such as a universal serial bus (USB), an Ethernet (registered trademark) port, a wireless LAN (local area network), and Bluetooth (registered trademark).

Examples of the input portion may include various input apparatuses such as a keyboard, a mouse, a touch panel, and a touchpad.

Note that the external interface and the input portion only need to be provided as required, and may be omitted.

### 2. Method for performing optical axis adjustment in laser interferometer

A method for performing optical axis adjustment in a laser interferometer according to an embodiment will next be described. Note in the following description that a method for performing optical axis adjustment in the laser interferometer 1 described above will be described by way of example.

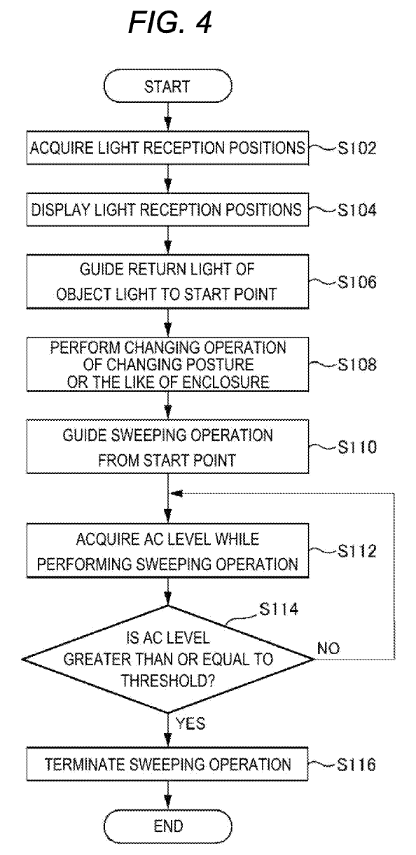

FIG. 4 is a flowchart showing the configuration of the method for performing optical axis adjustment in the laser interferometer according to the embodiment.

In step S102 shown in FIG. 4, the second light receiver 32 receives the return light L4 of the reference light L2 and the return light L5 of the object light L3. The second light receiver 32 thus acquires the light reception positions where the return light L4 and the return light L5 are received.

In step S104, the light reception position display 56 displays the light reception positions where the return light L4 and the return light L5 have been received and which have been acquired by the second light receiver 32.

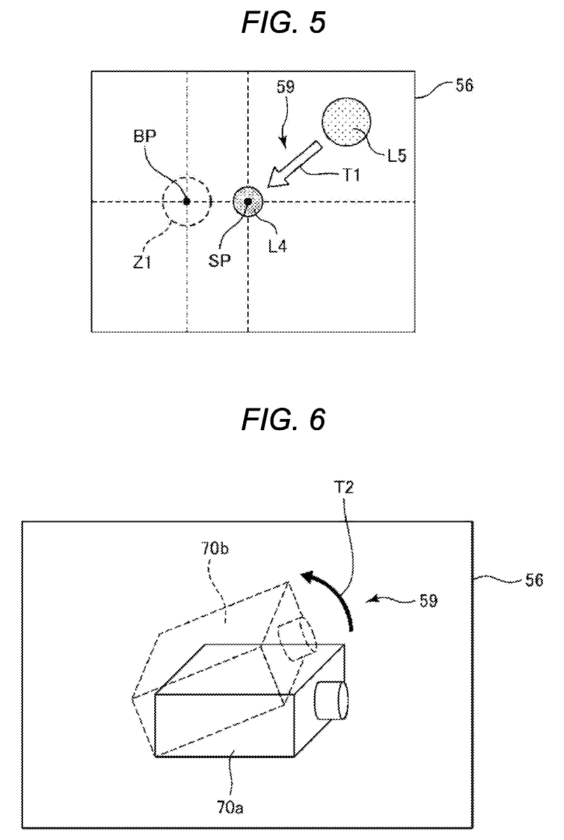

FIG. 5 shows an example of the light reception positions where the return light L4 and the return light L5 are received and a warning range Z1, which are displayed on the light reception position display 56.

The light reception position where the return light L4 is received shown in FIG. 5 is located substantially at the center of the light reception position display 56. In contrast, the light reception position where the return light L5 is received shown in FIG. 5 is an example of the position before the optical axis adjustment. To perform the optical axis adjustment in the laser interferometer 1, it is preferable to first move the return light L5 to a predetermined start point SP and then perform the operation of sweeping the return light L5 in a predetermined direction.

In step S106, the return light L5 of the object light L3 is therefore guided to the start point SP. FIG. 5 shows a symbol T1, which indicates teaching the user to guide the return light L5 to the start point SP. The symbol T1 is an arrow-shaped graphic, and indicates a direction in which and a distance by which the return light L5 is moved to the start point SP.

FIG. 5 further shows a base point BP. The base point BP represents a position where the return light L4 returns to the laser light source 2 when the light incident/exiting surface of the light modulator 12 is not tilted. The fact that the light reception position where the return light L4 is received deviates from the base point BP as shown in FIG. 5 indicates that the light incident/exiting surface of the light modulator 12 is tilted.

In FIG. 5, the warning range Z1 is set around the base point BP. The warning range Z1 indicates a range indicating that the return light L4 or L5 that falls within the range may enter the laser light source 2. The light reception position display 56 retaining the warning range Z1 in advance and displaying the warning range Z1 can lower the probability of accidental entry of the return light L4 or L5 into the laser light source 2 in the optical axis adjustment.

In step S108, the user performs the changing operation of changing the posture or the like of the enclosure 70 based on the teaching issued by the operation teaching portion 59. The return light L5 shown in FIG. 5 can thus be moved to the start point SP.

FIG. 6 shows an example in which the operation teaching portion 59 teaches the user to change the posture of a graphic 70a, which imitates the enclosure 70, to the posture of a graphic 70b. In FIG. 6, the operation teaching portion 59 teaches the user to change the posture of the enclosure 70 by displaying the graphics 70a and 70b, which imitate the enclosure 70, and an arrow-shaped symbol T2 on the light reception position display 56. Issuing the teaching described above allows the changing operation to be efficiently performed even when the user has little experience.

In step S110, the sweeping operation from the start point SP is guided.

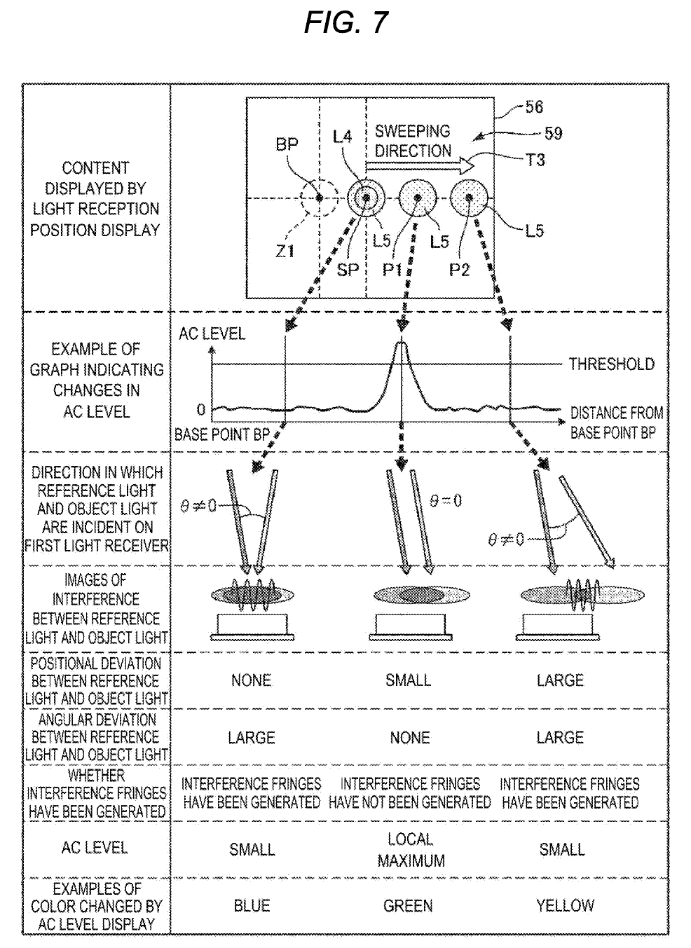

FIG. 7 shows a table that summarizes the relationship among three positions through which the return light L5 passes in the course of the sweeping operation and which are displayed on the light reception position display 56 shown in FIG. 5, the AC level corresponding to each of the positions, the directions in which the reference light L2 and the object light L3 are incident, images of the interference between the reference light L2 and the object light L3, the positional deviation and the angular deviation between the reference light L2 and the object light L3, whether interference fringes have been generated, and the like. Note in FIG. 7 that the directions in which the reference light L2 and the object light L3 are incident on the first light receiver 10 are indicated by arrows, and that portions of the first light receiver 10 that are irradiated with the reference light L2 and the object light L3 are indicated by ellipses. The direction in which the reference light L2 is incident is indicated by relatively dark arrows, and the direction in which the object light L3 is incident is indicated by relatively light arrows. The portion irradiated with the reference light L2 is indicated by a relatively dark ellipse, the portion irradiated with the object light L3 is indicated by a relatively light ellipse, and the region where the light irradiated portions overlap with each other is indicated by a darkest ellipse.

In step S110, the sweeping operation is guided by displaying an arrow-shaped symbol T3, which prompts the user to move the return light L5 from the start point SP in the sweeping direction, on the light reception position display 56, as shown in FIG. 7.

In step S112, the AC level acquisition portion 57 acquires the AC level during the sweep operation being performed, and the AC level display 58 displays the AC level.

In the sweeping operation, the return light L5 is moved from the start point SP toward the side opposite the base point BP to search for a local maximum point of the AC level. That is, the operation of continuously changing the relative relationship between the enclosure 70 and the target object 14 is performed.

The graph shown in FIG. 7 shows the relationship between the distance from the base point BP in the sweeping operation and the AC level. The relationship between the distance and the AC level shown in FIG. 7 is expressed by a graph having a local maximum point. Note that the sweeping operation may be the operation of continuously changing the posture of the enclosure 70 or may be the operation of discontinuously changing the posture of the enclosure 70.

When the return light L5 is at the start point SP, the reference light L2 and the object light L3 overlap with each other at the light receiving surface of the first light receiver 10. However, the direction in which the reference light L2 is incident and the direction in which the object light L3 is incident are not parallel to each other. That is, let θ be the angle between the two light incident directions, θ is not zero. In this case, although there is no positional deviation between the reference light L2 and the object light L3, but there is an angular deviation between the reference light L2 and the object light L3, so that interference fringes are generated on the light receiving surface. The interference fringes cause a decrease in the AC level and hence a decrease in the S/N ratio (signal-to-noise ratio) of the light reception signal. Therefore, whether interference fringes have been generated cannot be evaluated only by whether there is a positional deviation, and it can be said that it is necessary to detect whether there is an angular deviation.

Therefore, in step S112, the optical axis adjustment is performed while checking the light reception positions where the return light L4 and the return light L5 are received, and further checking the AC level. The user can thus perform the changing operation while understanding the relationship between the light reception positions and the AC level, so that the optical axis adjustment can be more efficiently performed. That is, a local maximum point of the AC level can be readily searched for by performing the operation (sweeping operation) of moving the return light L5 from the start point SP in a predetermined direction while checking the AC level displayed on the AC level display 58.

In the graph shown in FIG. 7, the AC level is locally maximized when the return light L5 overlaps with a position P1. The local maximum point shown in FIG. 7 exceeds a threshold set in advance. The position P1 can therefore be regarded as a position where a sufficient AC level is provided. When the return light L5 is at the position P1, the positional deviation between the reference light L2 and the object light L3 is small and there is no angular deviation therebetween at the light receiving surface of the first light receiver 10. The angle θ between the two light incident directions therefore satisfies θ = 0, so that no interference fringes are generated. In this case, it can be considered that the optical axis adjustment in the laser interferometer 1 is completed.

It is preferable that the AC level display 58 includes a light emitter that emits light having color that changes in conjunction with the AC level during the sweeping operation. FIG. 7 shows a case where the light emitter emits light the color of which has changed to blue when the return light L5 is at the start point SP. Since the user can sensuously recognize that the return light L5 is at the start point SP by visually recognizing the change in color, the optical axis adjustment can be more efficiently performed.

When the AC level exceeds the threshold, it is preferable to cause the light emitter to emit light having a different color. That is, the light emitter provided in the AC level display 58 preferably changes the color of the light in accordance with the AC level. FIG. 7 shows a case where the light emitter emits light the color of which has changed to green when the return light L5 is at the position P1. The user can thus sensuously recognize that the AC level exceeds the threshold. Note that it is not always necessary to search for a local maximum point, and a position where the AC level exceeds the threshold only needs to be searched for.

When the light reception position where the return light L5 is received falls within the warning range Z1, it is preferable to cause the light emitter to emit light having another different color. For example, when the return light L5 falls within the warning range Z1, it is preferable to cause the light emitter to emit light the color of which has changed to red. The user can thus sensuously recognize that the return light L5 falls within the warning range Z1.

In step S114, it is determined whether the AC level is greater than or equal to the threshold (whether predetermined condition is satisfied). When the return light L5 is at the position P1 shown in FIG. 7, the AC level is greater than or equal to the threshold (Yes in step S114), so that the control proceeds to the process in step S116 to terminate the sweeping operation. When the return light L5 is between the start point SP and the position P1 shown in FIG. 7, the AC level is smaller than the threshold (No in step S114), so that the control returns to the process in step S112 to continue the sweeping operation.

Consider a case where the return light L5 moves in the sweeping direction beyond the position P1 shown in FIG. 7 and reaches a position P2. In this case, the positional deviation between the reference light L2 and the object light L3 is large, and the angular deviation therebetween is also large at the light receiving surface of the first light receiver 10. Furthermore, interference fringes are generated on the light receiving surface, and the AC level is smaller than the threshold. Also in this case, the control returns to the process in step S112 to continue the sweeping operation.

Note that when the AC level is smaller than the threshold, it is preferable to cause the light emitter to emit light having a color different from any of the colors described above. FIG. 7 shows a case where the light emitter emits light the color of which has changed to yellow when the AC level is smaller than the threshold. The user can thus sensuously recognize that the AC level is insufficient.

According to the method described above, even when the user has little experience, the optical axis adjustment for suppressing generation of interference fringes can be efficiently performed. The decrease in the S/N ratio of the light reception signal can thus be suppressed in the laser interferometer 1.

### 3. First variation

A laser interferometer according to a first variation of the embodiment described above will next be described.

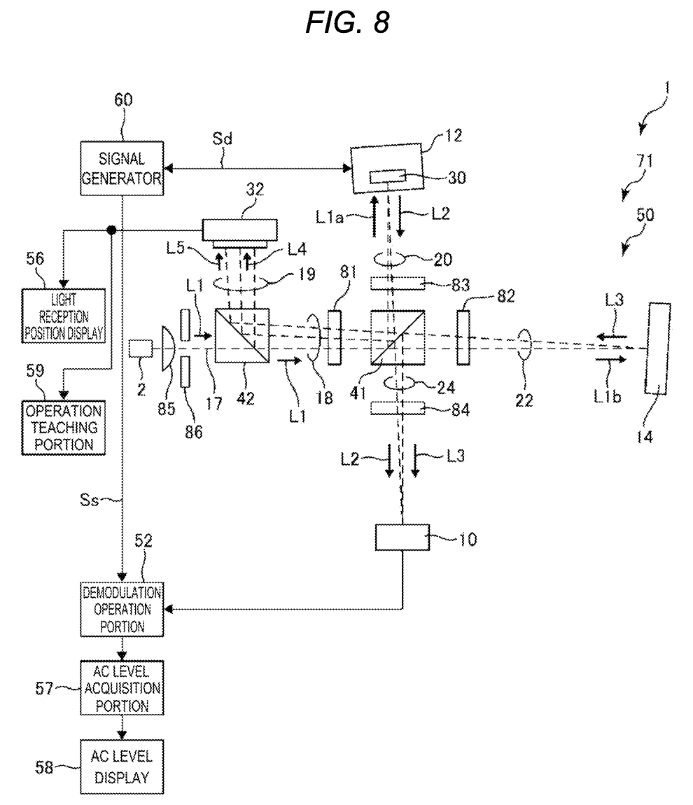

FIG. 8 is a schematic configuration diagram showing an interference optical system 50 provided in a laser interferometer 1 according to the first variation.

The first variation will be described below. In the following description, differences from the embodiment described above will be primarily described, and items that are the same as those in the embodiment described above will not be described. Note in FIG. 8 that elements that are the same as those in the embodiment described above have the same reference characters.

The laser interferometer 1 shown in FIG. 8 is the same as the laser interferometer 1 shown in FIG. 2 except that the interference optical system 50 is differently configured.

In the interference optical system 50 shown in FIG. 2 described above, the laser light L1 output from the laser light source 2 propagates along the optical path 17, is partially reflected off the second light splitter 42, and travels along the optical path 18. After propagating along the optical path 18, the return light L4 and the return light L5 partially pass through the second light splitter 42 and are received by the second light receiver 32.

In contrast, in the interference optical system 50 shown in FIG. 8, the laser light L1 output from the laser light source 2 propagates along the optical path 17, partially passes through the second light splitter 42, and travels along the optical path 18. After propagating along the optical path 18, the return light L4 and the return light L5 are partially reflected off the second light splitter 42 and received by the second light receiver 32.

Therefore, also in the laser interferometer 1 shown in FIG. 8, the optical axis adjustment for suppressing generation of interference fringes can be efficiently performed, as in the laser interferometer 1 shown in FIG. 2.

The first variation described above also provides advantages that are the same as those provided by the embodiment described above.

### 4. Second variation

A laser interferometer according to a second variation of the embodiment described above will next be described.

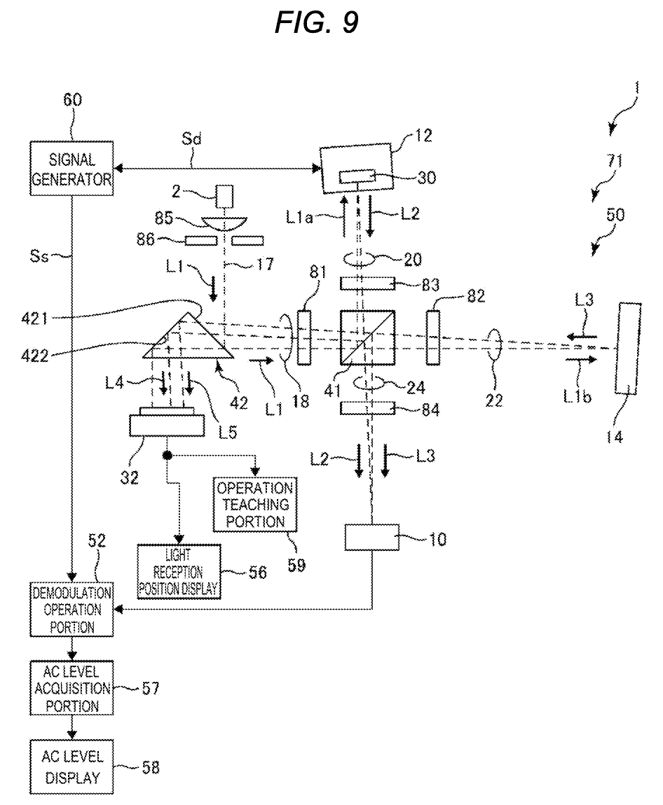

FIG. 9 is a schematic configuration diagram showing the interference optical system 50 provided in the laser interferometer 1 according to the second variation.

The second variation will be described below. In the following description, differences from the embodiment described above will be primarily described, and items that are the same as those in the embodiment described above will not be described. Note in FIG. 9 that configurations that are the same as those in the embodiment described above have the same reference characters.

The laser interferometer 1 shown in FIG. 9 is the same as the laser interferometer 1 shown in FIG. 2 except that the interference optical system 50 is differently configured.

In the interference optical system 50 shown in FIG. 9, a triangular prism is used as the second light splitter 42. The second light splitter 42 configured with the triangular prism has an external reflection surface 421 and an internal reflection surface 422. The external reflection surface 421 has the function of reflecting part of the laser light L1 and transmitting part of the return light L4 and the return light L5. The internal reflection surface 422 has the function of reflecting the return light L4 and the return light L5 having passed through the external reflection surface 421. The return light L4 and the return light L5 reflected off the internal reflection surface 422 are received by the second light receiver 32.

The second variation described above also provides advantages that are the same as those provided by the embodiment described above.

### 5. Advantages provided by embodiment and variations described above

As described above, the laser interferometer 1 according to each of the embodiment and the variations described above includes the laser light source 2, the first light splitter 41, the light modulator 12, the first light receiver 10, the second light splitter 42, the second light receiver 32, the light reception position display 56, the AC level acquisition portion 57, and the AC level display 58. The laser light source 2 outputs the laser light L1. The first light splitter 41 splits the laser light L1 into the first light L1a and the second light L1b. The light modulator 12 modulates the frequency of the first light L1a to generate the reference light L2. The first light receiver 10 receives the reference light L2 and the object light L3, which is generated by irradiating the target object 14 with the second light L1b, and outputs a light reception signal based on the intensity of the received light. The second light splitter 42 is disposed in the optical paths 17 and 18, which couple the laser light source 2 and the first light splitter 41 to each other, and guides the return light L4 of the reference light L2 and the return light L5 of the object light L3, which are generated at the first light splitter 41, to the optical path 19 (second optical path) different from the optical path 17 (first optical path) extending toward the laser light source 2. The second light receiver 32 is disposed in the optical path 19 and acquires the light receiving positions where the return light L4 of the reference light L2 and the return light L5 of the object light L3 are received. The light reception position display 56 displays the acquired light reception positions. The AC level acquisition portion 57 acquires the AC level generated by the interference between the reference light L2 and the object light L3 contained in the light reception signal. The AC level display 58 displays the acquired AC level.

According to the configuration described above, the laser interferometer 1 can be a laser interferometer capable of efficiently performing the optical axis adjustment to suppress generation of interference fringes and suppressing a decrease in the S/N ratio of the light reception signal.

The laser interferometer 1 may include the enclosure 70 and the operation teaching portion 59. The enclosure 70 houses the laser light source 2, the first light splitter 41, the light modulator 12, the first light receiver 10, the second light splitter 42, and the second light receiver 32. The operation teaching portion 59 teaches the user to perform the changing operation of changing the relative relationship between the enclosure 70 and the target object 14 based on the light reception positions where the return light L4 and the return light L5 are received.

According to the configuration described above, the optical axis adjustment can be efficiently performed even when the user has little experience.

In the laser interferometer 1, the operation teaching portion 59 may teach the user to perform the sweeping operation of changing the relative relationship between the enclosure 70 and the target object 14. In this case, the AC level acquisition portion 57 acquires changes in the AC level during the sweeping operation.

According to the configuration described above, the user can perform the changing operation while understanding the relationship between the light reception positions and the AC level, so that the user can more efficiently perform the optical axis adjustment.

In the laser interferometer 1, the operation teaching portion 59 may teach the user to perform the changing operation in a way that the light reception position where the return light L5 of the object light L3 is received is guided to the start point SP of the sweeping operation.

According to the configuration described above, a local maximum point of the AC level can be readily searched for by sweeping the return light L5 from the start point SP in a predetermined direction.

In the laser interferometer 1, the operation teaching portion 59 may change the content of the teaching in accordance with the AC level.

According to the configuration described above, the user can sensuously recognize the AC level.

In the laser interferometer 1, the operation teaching portion 59 may change the content of the teaching when the AC level exceeds a threshold.

According to the configuration described above, the user can sensuously recognize that the AC level has exceeded the threshold.

In the laser interferometer 1, the light reception position display 56 may retain in advance a range indicating that the return light L5 of the object light L3 that falls within the range affects the laser light source 2 as the warning range Z1. In this case, when the light reception position where the return light L5 is received enters the warning range Z1, the operation teaching portion 59 may change the content of the teaching.

According to the configuration described above, the probability of accidental entry of the return light L4 and the return light L5 into the laser light source 2 can be lowered.

In the laser interferometer 1, the light reception position display 56 may display the content of the teaching issued by the operation teaching portion 59.

According to the configuration described above, since the user can visually recognize the light reception positions and the content of the teaching at the same time, the user can reflect the content of the teaching in the user's operation and check the result of the operation. As a result, the accuracy and reliability of the operation can be improved.

In the laser interferometer 1, the splitting ratio of the second light splitter 42 in accordance with which the return light L4 of the reference light L2 and the return light L5 of the object light L3 are each split is preferably so set that the amount of light traveling along the optical path 19 (second optical path) is smaller than the amount of light traveling along the optical path 17 (first optical path).

According to the configuration described above, also when the laser light L1 is split by the second light splitter 42, the amount of light traveling toward the first light splitter 41 can be increased. As a result, the amount of each of the reference light L2 and the object light L3 received by the first light receiver 10 can be increased. When the return light L4 and the return light L5 are split by the second light splitter 42, the amount of light traveling toward the laser light source 2 is relatively large, and the amount of light traveling toward the second light receiver 32 is relatively small, but the second light receiver 32 can acquire the light reception positions even when the amount of each of the return light L4 and the return light L5 is small, so that problems hardly occur.

In the laser interferometer 1, the optical path length OL1 of the optical path 17 (first optical path) and the optical path length OL2 of the optical path 19 (second optical path) are preferably equal to each other.

According to the configuration described above, the positions where the return light L4 and the return light L5 returning along the optical path 17 reach the laser light source 2 therefore coincide with the positions where the return light L4 and the return light L5 returning along the optical path 19 reach the second light receiver 32. That is, the latter positions reached by the two types of return light reflect the former positions reached by the two types of return light. Detecting the latter positions reached by the two types of return light with the second light receiver 32 therefore allows the former positions reached by the two types of return light to be more accurately monitored.

The method for performing optical axis adjustment in a laser interferometer according to the embodiment described above is a method for performing optical axis adjustment in the laser interferometer 1. The laser interferometer 1 includes the laser light source 2, the first light splitter 41, the light modulator 12, the first light receiver 10, the second light splitter 42, and the second light receiver 32. The laser light source 2 outputs the laser light L1. The first light splitter 41 splits the laser light L1 into the first light L1a and the second light L1b. The light modulator 12 modulates the frequency of the first light L1a to generate the reference light L2. The first light receiver 10 receives the reference light L2 and the object light L3, which is generated by irradiating the target object 14 with the second light L1b, and outputs a light reception signal based on the intensity of the received light. The second light splitter 42 is disposed in the optical paths 17 and 18, which couple the laser light source 2 and the first light splitter 41 to each other, and guides the return light L4 of the reference light L2 and the return light L5 of the object light L3, which are generated at the first light splitter 41, to the optical path 19 (second optical path) different from the optical path 17 (first optical path) extending toward the laser light source 2. The second light receiver 32 is disposed in the optical path 19 and acquires the light receiving positions where the return light L4 of the reference light L2 and the return light L5 of the object light L3 are received.

The method for performing the optical axis adjustment in the laser interferometer according to the embodiment described above includes step S108, step S112, and step S116. In step S108, the light reception position where the return light L5 of the object light L3 is received is moved to the start point by performing the changing operation of changing the relative relationship between the laser interferometer 1 and the target object 14 based on the light reception positions acquired by the second light receiver 32. In step S112, the AC level generated by the interference between the reference light L2 and the object light L3 contained in the light reception signal is acquired while the sweeping operation of continuously changing the relative relationship is performed from the start point. In step S116, when the acquired AC level satisfies a predetermined condition, the sweeping operation is terminated.

According to the configuration described above, the optical axis adjustment for suppressing generation of interference fringes can be efficiently performed for the laser interferometer 1.

The laser interferometer according to the embodiment of the present disclosure has been described above with reference to the drawings, but not limited thereto, and the configuration of each of the elements that constitute the laser interferometer can be replaced with any configuration having the same function. Any other constituent element can be added to the laser interferometer according to the embodiment described above. Furthermore, the method for performing optical axis adjustment in the laser interferometer according to the embodiment of the present disclosure may be the method according to the embodiment to which a step for any purpose is added.

The laser interferometer according to the embodiment of the present disclosure can be used, for example, in a vibrometer, a tilt meter, a distance meter (length measuring device), and the like in addition to the displacement meter and the speedometer described above. In addition, examples of applications of the laser interferometer according to the embodiment of the present disclosure may include: an optical comb interference measurement technology for enabling distance measurement, 3D imaging, spectroscopy, and the like; an optical fiber gyroscope that realizes an angular velocity sensor, an angular acceleration sensor, and the like; and a Fourier spectrometer including a moving mirror device.

Two or more of the laser light source, the light modulator, the first light receiver, and the second light receiver may be placed on the same substrate. Therefore, the size and the weight of the interference optical system can be readily reduced, and the interference optical system can be more readily assembled.

The laser interferometer according to the above embodiment of the present disclosure includes what is called a Michelson interference optical system, and can instead include an interference optical system of another type, for example, a Mach-Zehnder interference optical system.

What is claimed is:

1. A laser interferometer comprising:
a laser light source configured to output laser light;
a first light splitter configured to split the laser light into first light and second light;
a light modulator configured to modulate a frequency of the first light to generate reference light;
a first light receiver configured to receive the reference light and object light generated by irradiating a target object with the second light and output a light reception signal based on an intensity of the received light;
a second light splitter disposed in an optical path that couples the laser light source and the first light splitter to each other and configured to guide return light of the reference light and return light of the object light to a second optical path different from a first optical path extending toward the laser light source;
a second light receiver disposed in the second optical path and configured to acquire light reception positions where the return light of the reference light and the return light of the object light are received;
a processor configured to acquire an AC level generated by interference between the reference light and the object light from the light reception signal; and
at least one display configured to display at least one of the acquired light reception positions and the acquired AC level.

2. The laser interferometer according to claim 1, further comprising:
an enclosure configured to house the laser light source, the first light splitter, the light modulator, the first light receiver, the second light splitter, and the second light receiver; and
an operation teaching portion configured to teach a changing operation of changing a relative relationship between the enclosure and the target object based on the light reception positions.

3. The laser interferometer according to claim 2, wherein
the operation teaching portion is configured to teach a sweeping operation of changing the relative relationship, and
the processor is configured to acquire changes in the AC level during the sweeping operation.

4. The laser interferometer according to claim 3, wherein the operation teaching portion is configured to teach the changing operation in a way that the light reception position where the return light of the object light is received is guided to a start point of the sweeping operation.

5. The laser interferometer according to claim 2, wherein the operation teaching portion is configured to change a content of the teaching in accordance with the AC level.

6. The laser interferometer according to claim 5, wherein the operation teaching portion is configured to change the content of the teaching when the AC level exceeds a threshold.

7. The laser interferometer according to claim 2, wherein
the display is configured to retain in advance a range indicating that the return light of the object light that falls within the range affects the laser light source as a warning range, and
the operation teaching portion is configured to change a content of the teaching when at least one of the light reception positions falls within the warning range.

8. The laser interferometer according to claim 2, wherein the display is configured to display a content of the teaching issued by the operation teaching portion.

9. The laser interferometer according to claim 1, wherein a splitting ratio of the second light splitter, in accordance with which the return light of the reference light and the return light of the object light are each split, is so set that an amount of light traveling along the second optical path is smaller than an amount of light traveling along the first optical path.

10. The laser interferometer according to claim 1, wherein an optical path length of the first optical path is equal to an optical path length of the second optical path.

11. A method for performing optical axis adjustment in a laser interferometer, the laser interferometer including
a laser light source configured to output laser light,
a first light splitter configured to split the laser light into first light and second light,
a light modulator configured to modulate a frequency of the first light to generate reference light,
a first light receiver configured to receive the reference light and object light generated by irradiating a target object with the second light and output a light reception signal based on an intensity of the received light,
a second light splitter disposed in an optical path that couples the laser light source and the first light splitter to each other and configured to guide return light of the reference light and return light of the object light to a second optical path different from a first optical path extending toward the laser light source, and
a second light receiver disposed in the second optical path and configured to acquire light reception positions where the return light of the reference light and the return light of the object light are received,
the method comprising:
moving the light reception position where the return light of the object light is received to a start point by performing a changing operation of changing a relative relationship between the laser interferometer and the target object based on the light reception positions acquired by the second light receiver;
acquiring an AC level generated by interference between the reference light and the object light from the light reception signal while performing a sweeping operation of continuously changing the relative relationship from the start point; and
terminating the sweeping operation when the acquired AC level satisfies a predetermined condition.
